(19) United States
(12) Patent Application Publication
(10) Pub. No.: US 2005/0163225 A1
(43) Pub. Date: Jul. 28, 2005

(54) Apparatus for decoding video and method thereof

(75) Inventors: Jin Seok Im, Gyeonggi-do (KR); Eung Tae Kim, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/042,079

(22) Filed: Jan. 26, 2005

(30) Foreign Application Priority Data
Jan. 27, 2004 (KR) 10-2004-0005057

(51) Int. Cl. H04N 7/12

(52) U.S. Cl. 375/240.25

(57) ABSTRACT

The present invention provides an apparatus and method for decoding a video clip image as well as a moving picture of a specific channel compressed by MPEG using a video decoder. Specifically, the present invention restores video clip data such as a data broadcast intra frame still picture, a video drip, and the like using the video decoder to output the restored data to a screen, thereby reducing the load and memory access of the host processor. And, the present invention decodes animation OSD data via the video decoder to output to the screen, thereby implementing high quality OSD with an inexpensive cost.

This application claims the benefit of the Korean Application No. 10-2004-0005057 filed on Jan. 27, 2004, which is hereby incorporated by reference.

### BACKGROUND OF THE INVENTION

1. Field of the Invention

The present invention relates to a video decoder which restoring digital video compressed by MPEG (moving picture experts group), and more particularly, to an apparatus and method for decoding a video clip stored in a memory as well as compressed moving pictures as a main screen using the video decoder.

2. Discussion of the Related Art

Generally, a digital TV reduces its transmission error lower than that of an analog TV to prevent noise and image overlap, thereby implementing high quality of sound and image. Moreover, by compressing to transmit data such as voice, video, characters, and the like by excellent digital compression, it is able to transmit various programs over one channel of a conventional TV so that more information can be provided via multi-channels.

Such a high definition TV rapidly replaces an analog TV and its application range is getting more complex and diversified.

The digital TV is advantageous in enabling the relatively errorless transmission of complex and diverse information and the restoration of the received information, whereas the conventional TV aims at unidirectional transmission of audio and video. Data broadcast, which selectively receives information needed by a viewer with interest in a manner of providing traffic information, news, stock market information, and the like by taking advantage of enabling the transmission of larger volume of data, corresponds to one of characteristics of the digital TV.

The digital TV evolves from unidirectional broadcasting employed as current major broadcasting into an interactive or two-way serviceable digital TV that can directly adopt a viewer's request. This is to inform a broadcast service provider of the viewer's request via a return channel connected to the digital TV such as a modem, Internet, dedicated line, etc. and to return an appropriate service to the viewer.

For instance, shopping, order, delivery confirmation, and the like for the goods related to a program are available through a TV screen. And, order and payment for a specific movie in a movie channel classified into various themes are enabled via a return channel. Thus, various two-way or bi-directional services are available.

One of various methods of implementing the bi-directional service via the data broadcast includes the steps of transferring a data packet carrying a still picture or moving picture clip, picture elements, text information and the like necessary for a transmitting side and making a final picture by applying, restoring, and combining the transmitted packet to a processor of each element in a receiving side. If so, a viewer receives various kinds of necessary information via an output screen or transfers his/her request to the transmitting side over the return channel via a menu button on a screen.

Moreover, an MPEG intra frame still picture used for a background image or a sub-screen image among image elements of data broadcast, a video drip configured with MPEG I/P frames, and the like are transferred in the format of data packet or supplementary video packet. If so, a digital TV receives the data packet or the supplementary packet via modem, Internet, cable, or the like connected thereto. For instance, limitations and operational methods of data broadcast video drip are described in detail in DVB-MHP (digital video broadcasting-multimedia home platform) developed as data broadcasting standards in Europe.

In case of intending to check the contents of the data packet or the supplementary data packet acquired via the modem, Internet, cable, or the like connected to the TV in a manner of displaying the data packet or the supplementary data on a screen, decoding is carried out using a host processor. Namely, in the related art, the host processor is totally used in decoding the video clip used for the background image or the sub-picture image together with the moving picture image that is the main picture.

However, the decoding using the host processor needs a processor of high performance to raise the cost. And, the frequent memory access may result in performance reduction of an overall decoder system.

### SUMMARY OF THE INVENTION

Accordingly, the present invention is directed to an apparatus for decoding video and method thereof that substantially obviates one or more problems due to limitations and disadvantages of the related art.

An object of the present invention is to provide an apparatus for decoding video and method thereof, by which various video clips inputted via various input sources to be stored in a memory are restored using a video decoder and by which the restored video clips are displayed on a screen.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an apparatus for decoding video according to the present invention includes a memory storing a compressed moving picture data of a specific channel transferred in a video packet format and a compressed video clip data transferred in a data packet format in designated areas, respectively, a host processor controlling a memory range and location of the compressed video clip data, a selection unit selecting to output one of the compressed moving picture data and the video clip data, and a video decoder decoding the compressed data outputted from the selection unit by applying MPEG algorithm thereto under a control of the host processor.

Preferably, the video clip data is a compressed encoded data having MPEG coding algorithm applied thereto. And, the video clip data includes an MPEG intra frame still picture data or a video drip image data transferred in the data packet format via at least one of a modem, Internet, and a cable.

Preferably, the video clip data includes an animation OSD data.

Preferably, the host processor sets up a location and storage range of a memory in firstly decoding a first picture if the inputted video clip data is a consecutive video sequence.

Preferably, if the inputted video clip data is a single still picture, the host processor sets up a location and storage range of a memory whenever the still picture is inputted.

Preferably, if the data inputted to the video decoder is the video clip data, the host processor controls the video decoder to search a bit stream from a start address of a memory having the video clip data stored therein so that the video recorder starts to decode the bit stream by picture unit after a valid GOP has been found.

Preferably, if the video decoder is a dual video decoder, the compressed moving picture data and the compressed video clip data are simultaneously received so that the received data are decoded to be outputted.

In another aspect of the present invention, an apparatus for decoding video includes a memory storing compressed moving picture data of first and second channels transferred in a video packet format and a compressed video clip data transferred in a data packet format in designated areas, respectively, a host processor controlling a memory range and location of the compressed video clip data, a selection unit selectively outputting at least one of the compressed moving picture data of the first and second channels and the video clip data, a dual video decoder simultaneously decoding the compressed moving picture data of the channels selected by a user via the selection unit and the video clip data by picture unit by applying MPEG algorithm thereto under a control of the host processor if the compressed moving picture data of the channels selected by the user via the selection unit and the video clip data are outputted, and a video synthesizing unit blending to output a moving picture and a video clip image outputted from the dual video decoder according to a predefined blending ratio.

In another aspect of the present invention, in a digital TV receiver including a memory storing a compressed moving picture data transferred in a video packet format and a compressed video clip data transferred in a data packet format in designated areas, respectively, a method of decoding video includes a step (a) of selecting to output one of the compressed moving picture data and the video clip data from the memory, a step (b) of if the video clip data is selected and outputted in the step (a), deciding whether the video clip data is a valid MPEG data, and a step (c) of if the video clip data is decided as the valid MPEG data in the step (b), performing video decoding on the valid video clip data within a range of the memory by MPEG decoding algorithm.

In a further aspect of the present invention, in a digital TV receiver including a memory storing compressed moving picture data of first and second channels transferred in a video packet format and a compressed video clip data transferred in a data packet format in designated areas, respectively, a method of decoding video includes a step (a) of selecting to output at least one of the compressed moving picture data and the compressed video clip data from the memory, a step (b) of if the compressed moving picture data of one of the first and second channels and the video clip data are selected and outputted, simultaneously decoding to output the compressed moving picture data and the video clip data, and a step (c) of blending to display a moving picture and a video clip image outputted in the step (b) according to a predefined blending ratio.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a video decoding apparatus according to one embodiment of the present invention;

FIG. 2 is a block diagram of a video decoding apparatus according to another embodiment of the present invention;

FIG. 3 is a flowchart of a video decoding method according to the present invention;

FIG. 4 is a block diagram of a video synthesis of a video synthesizing unit in FIG. 1 or FIG. 2;

FIG. 5 is a pictorial diagram of an image of data broadcast according to one embodiment of the present invention; and

FIG. 6 is a pictorial diagram of an image of data broadcast according to another embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

First of all, the present invention is characterized in that a video clip stored in a memory is decoded using a video decoder. Specifically, in case that the video decoder is a dual decoder, the present is characterized in that a compressed moving picture as a main picture is decoded the moment the video clip stored in the memory is decoded.

A video decoder used for a latest digital TV has developed to enable high quality dual decoding. In case of using such a video decoder, a video clip can be efficiently decoded as well as a compressed moving picture. Namely, in decoding to output two channels simultaneously to a screen, the video clip is decoded using a host processor. Yet, in case of decoding one channel only, the video clip is decoded using a video coder responsible of the rest channel.

In the present invention, in displaying to check the contents of an MPEG video clip, which is acquired via modem, Internet, cable, or the like connected to a TV, on a screen, if the video clip is restored not using the host processor but using the video decoder provided inside, the contents can be easily displayed on the screen with a low cost.

If a device for storing a portion of moving pictures in a memory for an OSD (on screen display) function of a TV system and restoring to display the stored portion is provided, a viewer can use various setup menus via a moving OSD picture. And, the moving OSD picture can be used for a congratulation animation for celebrating acquisition of high points in a game or the like provided by the TV itself and the like. Specifically, it will be very useful in gracefully implementing various kinds of information represented via OSD such as TV setup menu, time, program guide, program record reservation, and the like to display on a screen.

For convenience of explanation inn the present invention, various video clips such as an MPEG intra frame (I-frame) still picture, a video drip exerting a slightly changeable screen effect using a consecutive video sequence, a data broadcast still picture, a compressed moving picture for animation OSD (on screen display) to provide a graceful user interface, a compressed still picture or moving pictures inputted via Internet or the like, etc. are generally defined as a video clip.

A video decoder that decodes the video clip can be a single video decoder or a dual video decoder.

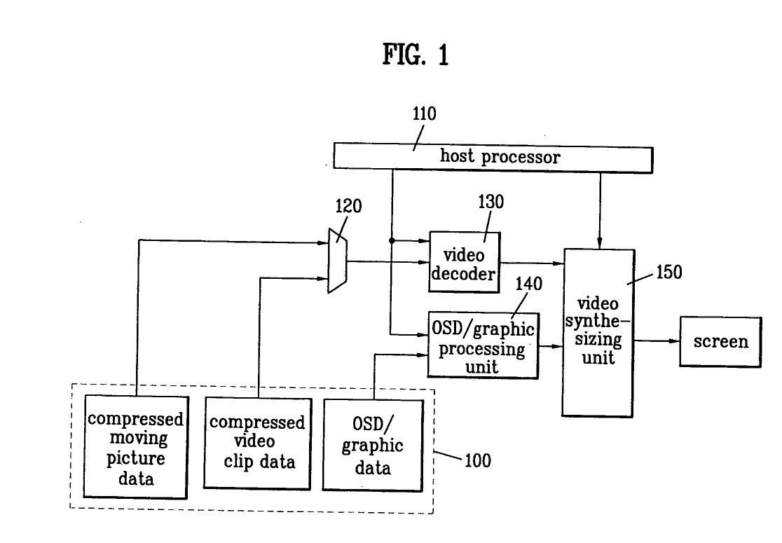

FIG. 1 is a block diagram of a video decoding apparatus according to one embodiment of the present invention.

Referring to FIG. 1, a memory area 100 is divided into a compressed moving picture data area for storing compressed moving picture data therein, a video clip data area storing video clip data therein, and an OSD/graphic data area storing general OSD/graphic data therein.

And, one of the compressed moving picture data and the video clip data stored in the memory 100 is outputted to a video decoder 130 via a selection unit 120.

The general OSD/graphic data stored in the memory 100 are outputted to a video synthesizing unit 150 via an OSD/graphic processing unit 140.

The video decoder 130 applies MPEG decoding algorithm to the inputted compressed moving picture data or the inputted video clip to output to the video synthesizing unit 150. The video synthesizing unit 150 synthesizes outputs of the video decoder 130 and the OSD/graphic processing unit 140 to display on a TV screen. In doing so, the video decoder 130, the OSD/graphic processing unit 140, and the video synthesizing unit 150 are controlled by a host processor 110. If the video clip data are inputted via modem, Internet, cable, or the like connected to a TV, the host processor 110 determines a memory location where the video clip data will be stored and then stores the video clip data in the determined memory location.

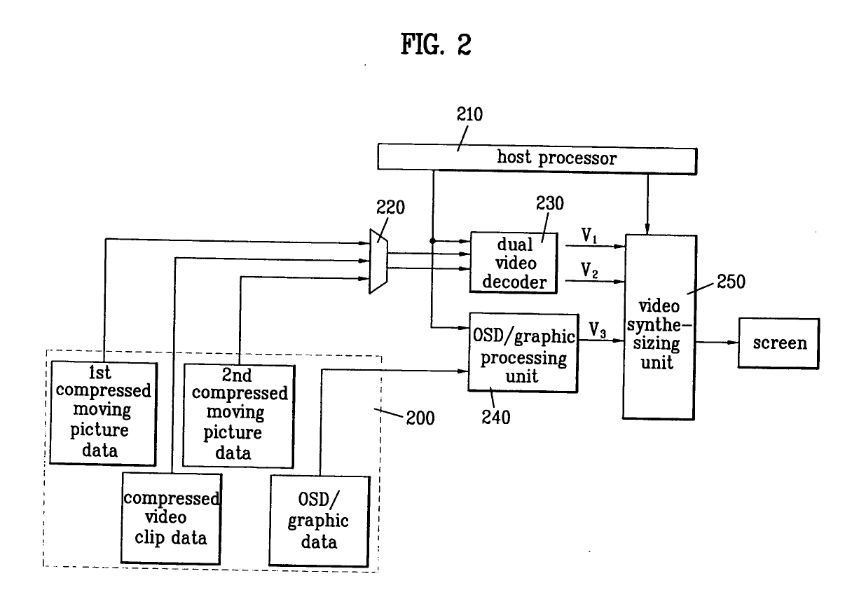

FIG. 2 is a block diagram of a video decoding apparatus according to another embodiment of the present invention.

Referring to FIG. 2, a memory area 200 is divided into a first compressed moving picture data area storing compressed moving picture data of a first channel therein, a second compressed moving picture data area storing compressed moving picture data of a second channel therein, a video clip data area storing video clip data therein, and an OSD/graphic data area storing general OSD/graphic data therein.

At least one of the first compressed moving picture data, the second compressed moving picture data, and the video clip data is outputted to a dual video decoder 230 via a selection unit 220. For instance, in case of intending to decode the compressed moving picture data of two channels simultaneously, the first and second compressed moving picture data are outputted to the dual video decoder 230 via the selection unit 220. In case of decoding the compressed moving picture data and the video clip data of one channel, one of the first and second moving picture data and the video clip data are outputted to the dual video decoder 230 via the selection unit 220. Meanwhile, in case of intending to decode the compressed moving picture data of one channel only, one of the first and second compressed moving picture data is outputted to the dual video decoder 230 via the selection unit 220. On the other hand, in case of intending to decode the video clip data only, the video clip data are just outputted to the dual video decoder 230 via the selection unit 220.

The dual video decoder 230 is provided with a pair of video decoders inside. A pair of the video decoders decode compressed moving pictures of the respective channels simultaneously. Instead, one of the video decoders decodes the compressed moving picture data of one channel the moment the other video decoder decodes the video clip data.

The video decoder provided with the dual video decoding functions can be implemented using the conventional dual video decoder or a dual video decoder disclosed in Korean Patent Application No. 2003-85959 filed by the present applicant.

The two video data decoded in the dual video decoder 230 are outputted to a video synthesizing unit 250. The general OSD/graphic data stored in the memory 200 are outputted to the video synthesizing unit 250 via an OSD/graphic processing unit 240. The video synthesizing unit 250 synthesizes outputs of the dual video decoder 230 and the OSD/graphic processing unit 240 to display on a TV screen. In doing so, the dual video decoder 230, the OSD/graphic processing unit 240, and the video synthesizing unit 250 are controlled by a host processor 210.

In the above-configured present invention, the video decoding apparatus provided with the single video decoder decodes the compressed moving picture data of one channel only or the video clip data only using the single video decoder. On the other hand, the video decoding apparatus provided with the dual video decoder can simultaneously decode the compressed moving picture data of two channels using the dual video decoder or the compressed moving picture data and the video clip data of one channel. An operational explanation of the video decoding apparatus using the single video decoder corresponds to the case that the compressed moving picture or the video clip data of one channel is decoded in the video decoding apparatus using the dual video decoder.

Hence, the operation of the video decoding apparatus using the dual video decoder is explained in detail in the description of the present invention. And, the detailed explanation of the video decoding apparatus using the single video decoder is skipped in the following.

Namely, image configuring elements of the digital TV in the video decoding apparatus using the dual video decoder are divided into first compressed moving picture data, second compressed moving picture data, compressed video clip data, general OSD/graphic data, and the like according to usages and sources to be stored in different areas, as shown in FIG. 2, of the memory 200, respectively.

In this case, locations and ranges of the memory 200 designated for the first compressed moving picture data, the second compressed moving picture data, and the general OSD/graphic data are previously set up.

The location and range of the memory 200, in which the compressed video clip data are controlled by the host processor 210 when the video clip data are inputted.

Namely, each video clip, which is encoded and compressed according to MPEG algorithm, is inputted via various paths according to its usage and source. And, the inputted video clip data are stored in the compressed video clip data area of the memory 200 by a control of the host processor 210. In this case, the compressed video clip data can be used as a sub-picture such as a background image, a still picture, and a menu image and include an intra frame still picture, a video drip, an animation OSD, and the like.

The video clip data are transmitted from a transmitting side via data packets and the compressed moving picture data are transmitted via video packets.

The compressed moving picture data are separated by a system decoder (not shown in the drawing) to be stored in the corresponding area of the memory 200. In doing so, the compressed moving picture data of a first channel are stored in the first compressed moving picture data area of the memory 200 in the format of a bit stream and the compressed moving picture data of a second channel are stored in the second compressed moving picture data area of the memory 200 in the format of the bit stream.

The video clip data are processed by the host processor 210 to be stored in the corresponding memory area in the format of the bit stream.

In this case, the first and second channels mean a pair of channels tuned by a pair of tuners (not shown in the drawing) within the digital TV according to viewer's selections, respectively. Once the compressed moving picture data of the first and second channels are decoded by the dual video decoder 230, it is able to view a pair of the channels via one TV screen simultaneously. This can be implemented into a split screen, PIP (picture in picture), or the like on the TV screen.

In the present invention, the compressed moving picture data, which are stored in the first and second moving picture data areas of the memory 200 to display one channel or two channels like the split screen or PIP simultaneously, is called main screen compressed moving picture data. This is because the video clip data stored in the compressed video clip data area are used for a sub-screen, i.e., the background image, still picture, or OSD image.

The general OSD/graphic data are to display information, which should be known to or is necessary for a viewer, such as a system setup menu, a program guide, and the like on the screen. The general OSD data is different from the animation OSD data. Namely, the general OSD is to display a still picture of a menu represented as characters or graphics, whereas the animation OSD is to display a motion of a menu and the like on the screen.

So, the animation OSD data are stored in the compressed video clip data area of the memory 200 and are then outputted to the dual video decoder 230 via the selection unit 220. And, the OSD data are stored in the OSD/graphic data area and are then outputted to the OSD/graphic processing unit 240. In doing so, the host processor 210 stores the general OSD/graphic data in the OSD/graphic data area of the memory 200 in the format of bitmap.

The host processor 210 is responsible for mode setup and control of the respective devices for organic image configuration. For instance, after having moved necessary video sources to the corresponding areas of the memory 200, the host processor 210 commands a decoding to the dual video decoder 230 and the OSD/graphic processing unit 240 or designates a synthesis ratio, an image location, and the like between the respective image configuring elements via the video synthesizing unit 250.

The selection unit 220 selects at least one of the first compressed moving picture data, the second compressed moving picture data, and the compressed video clip data stored in the memory according to a user's selection to output to the dual video decoder 230.

For instance, if the user selects two channels simultaneously, the first and second compressed moving picture data are outputted to the dual video decoder 230 via the selection unit 220.

If the user selects one channel and the video drip, one of the first and second moving picture compressed data and the video clip data are outputted to the dual video decoder 230. If so, the dual video decoder 230 decodes the compressed moving picture data of the inputted channel according to a frame rate of the main screen moving picture and simultaneously decodes the video clip to output to the video synthesizing unit 250. Thus, the video image that will be displayed on the sub-screen or the background image can be viewed independently from the main screen.

For another instance, if a user selects one channel only, one of the first and second compressed moving picture data is outputted to the dual video decoder 230 via the selection unit 220. If a user selects one video clip only, the video clip data are outputted to the dual video decoder 230 via the selection unit 220. In this case, the video decoding apparatus including the dual video decoder operates in the same manner of the video decoding apparatus including the single video decoder.

Each of the video decoders of the dual video decoder 230 enables decoding of the moving picture compressed by MPEG. Hence, if the video clip is compressed by MPEG, the video decoder can decode the video clip regardless of still picture, video drip, and animation drip.

Meanwhile, in order to display the information, which needs to be known to or is necessary for a viewer, on a screen in the form of characters or graphics, the OSD/graphic processing unit 240 is needed. If necessary or according to a user's request, the OSD/graphic processing unit 240 reads the OSD/graphic data of the memory 200, processes the read data suitably for display, and then outputs the processed data to the video synthesizing unit 250. Namely, the OSD/graphic processing unit 240 is a device for processing the OSD or graphic data read from the OSD/graphic data area of the memory 200 to display on a screen in the form of OSD characters or graphics. For this, the host processor 210 processes the bitmap necessary for OSD/graphic to store in the OSD/graphic data area of the memory 200.

The video synthesizing unit 250 blends the data outputted from the dual video decoder 230 and the OSD/graphic processing unit 240 according to a synthesizing ratio of the respective video configuring elements to configure a final output image. For instance, the video synthesizing unit 250 synthesizes the main screen data and the video clip data (i.e., background image, sub-screen, animation OSD, etc.) outputted from the dual video decoder 230 and the OSD or graphic data outputted from the OSD/graphic processing unit 240 according to a predefined synthesizing ratio.

And, the video synthesizing unit 250 can receive to synthesize other image configuring elements such as text, caption information, and the like.

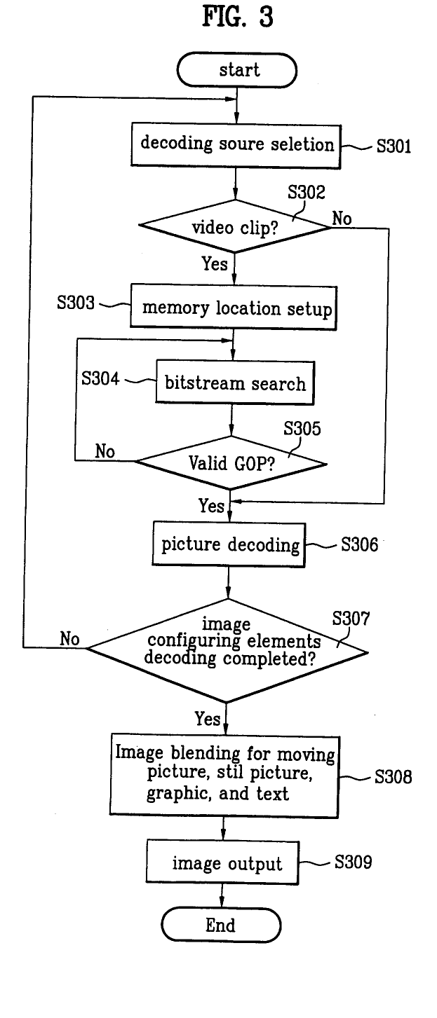

FIG. 3 shows an example of restoring image configuring elements using a video decoder, in which the video decoder corresponds to a single video decoder or one of two video decoders of a dual decoder.

First of all, a video source to be decoded according to a user's selection is selected from the memory 200 (S301). Namely, it is decided whether to restore the compressed moving picture data or the compressed video clip data from the memory 200. The selected video source is then inputted to the video decoder via the selection unit.

As mentioned in the foregoing description, the video clip data can be divided into the data broadcast image, animation OSD, and the like. Even if the video clip data are restored by one video decoder, the processing of the video synthesizing unit 250 should differ according to a species of the configuring elements in the final screen.

Once the video source to be decoded is decided in the step 301 and if the decided video source is decided as the video clip data (S302), the following steps S303 to S306 are sequentially executed. If the video source is decided as the compressed moving picture data in the step S302, the procedure directly goes to the step S306.

In doing so, if the video source to be decoded is the compressed video clip data, the location on the memory where the video clip data will be stored can be changed at any time for convenience of the host processor 210. Hence, it should be decided whether each picture corresponds to a consecutive video sequence or a single still picture and a location setup for a storage range of the memory 200 needs to be done according to a result of the decision (S303). If it corresponds to the consecutive video sequence, the storage range of the memory 200 is set up in decoding a first picture. Yet, if it corresponds to the single still picture, the memory location should be set up each time.

For instance, if the video clip data to be currently decoded corresponds to the data broadcast intra still picture, only one picture encoded into the intra frame should exist within the memory range. This is mainly used as the background image in data broadcasting. Since there exists no encoding according to motion compensation, a prior reference frame is unnecessary for video restoration.

In transmitting a still picture in data broadcasting, a case of using a method of transmitting a background image, which varies intermittently and slightly, via data packets is called a video drip. A decoding unit of the video drip is a picture unit. Yet, such a video drip is included in the consecutive video sequence. Namely, even if one picture is just encoded in the memory area of the video clip to be decoded, the previously decoded reference frame is needed. Hence, in case of a broadcast channel over which the video drip is transmitted, the memory for the reference frame should be always secured to provide a stable background image or sub-screen to a viewer.

In doing so, the memory range of the video clip data is set to a start address START_ADDR and an end address END_ADDR. Namely, a bit stream range of the video clip data to be decoded is limited by the start address START_ADDR and the end address END_ADDR indicating the stored location of the video clip data.

After completion of the memory range setup by the host processor 210, if receiving a decoding start command from the host processor 210, the video decoder sequentially searches the bit stream from a START_ADDR location of the memory 200 (S304) to decide a presence or non-presence of valid GOP (group of pictures) (S305). Such a procedure is to decide whether the bit stream is valid MPEG data or not. Namely, the valid MPEG data include the valid GOP structure.

If it is decided as the valid GOP in the step S305, the valid video clip data within the memory range are decoded by picture unit to be transferred to the video synthesizing unit 250 (S306). Namely, in the step S306, the bit stream after finding the valid GOP is decoded by picture unit and is then delivered to the video synthesizing unit 250.

Meanwhile, if it is decided as the compressed moving picture data in the step S302, the steps S303 to S305 are skipped but the step S306 is executed. In the step S306, the corresponding compressed moving picture data are read from the memory 200, are decoded by picture unit, and are then delivered to the video synthesizing unit 250. Subsequently, it is decided whether decoding for all video configuring elements is completed (S307). If the configuring elements to be decoded still remain, the procedure goes back to the step S301 to decode the next configuring element. If the decoding is completed, it proceeds to the next step S308. In case that the decoding of the respective configuring elements is completed, the video decoder informs the host processor of the valid information of the picture and the video sequence such as a compression specification of the video clip, a picture structure, and other associated information via an interrupt to provide flexibility to an image configuration. Namely, the video decoder informs the host processor of the valid information of the video sequence and picture in the process of the video clip decoding to provide the flexibility in deciding whether the corresponding picture will be used for a final output.

If it is decided that the decoding of the image configuring elements is completed in the step S307, the synthesizing processing for the respective image configuring elements is carried out in the step S308. The respective elements such as the program moving picture of the user-selecting channel, the decoded video clip, the animation OSD, the graphic data, the text information, and the like are blended according to a predefined ratio.

Namely, the video synthesizing unit 250 blends the data outputted from the video decoder 230 and the OSD/graphic processing unit 240 according to the predefined synthesizing ratio of the respective video configuring elements to configure a final output image. In other words, the main screen data and the video clip data (e.g., background image, sub-screen, animation OSD, etc.) outputted from the dual video decoder 230 and the OSD or graphic data outputted from the OSD/graphic processing unit 240 are synthesized according to the predefined synthesizing ratio. In doing so, the video synthesis is done by an overlay technique or a blending technique. The overlay technique is carried out in a manner of overlaying to output the videos outputted from the video decoder 230 and the OSD/graphic processing unit 240 with each other. And, the blending technique is an extension of the overlay technique, in which transparency of the overlaid videos is adjusted to be outputted. If so, the overlaid different videos can be simultaneously seen by a user. For instance, if the transparency of the moving picture data and the video clip data outputted from the dual video decoder 230 is adjusted, the user can view both of the moving picture and the video clip image on one screen despite the overlaid moving picture and video clip data. In doing so, the visibility depends on a blending coefficient α.

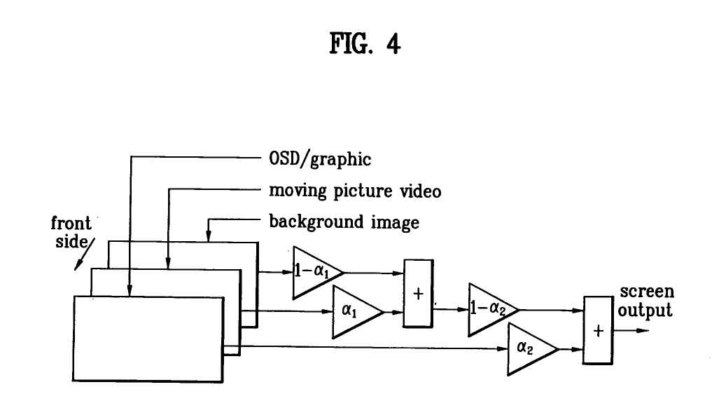

FIG. 4 is a block diagram of a video synthesis of the video synthesizing unit 250, in which a blending priority usable in the image synthesizing process is shown. In FIG. 4, a background image, a moving picture, and OSD/graphic data are displayed in order.

Referring to FIG. 4, blending coefficients α₁ and α₂ are set up by the host processor 210. Namely, the transparency of the moving picture image and the background image is adjusted according to a value of α₁. And, the transparency of the OSD/graphic data is adjusted according to a value of α₂.

For instance, assuming that the video clip data and the moving picture data outputted from the dual video decoder 230 are V1 and V2, respectively, a blending video V4 for the two data results from Formula 1.

[Formula 1]
V4=(1−α₁)V1+α₁V2

And, a blending video for the blending video V4 and the OSD/graphic data V3 results from Formula 2.

[Formula 2]
V5=(1−α₂)V4+α₂V3

Each of the blending coefficients α₁ and α₂ in Formula 1 and Formula 2 has a value between 0 and 1.

FIG. 4 shows hardware implementing Formula 1 and Formula 2.

The video clip video restored by the video clip decoding is blended with the moving picture of the main screen and the OSD/graphic video by the blending schemes of Formula 1 and Formula 2. And, the final blended output image is displayed on the screen via the host processor 210 according to options of a digital TV receiver system and a viewer's request (S309).

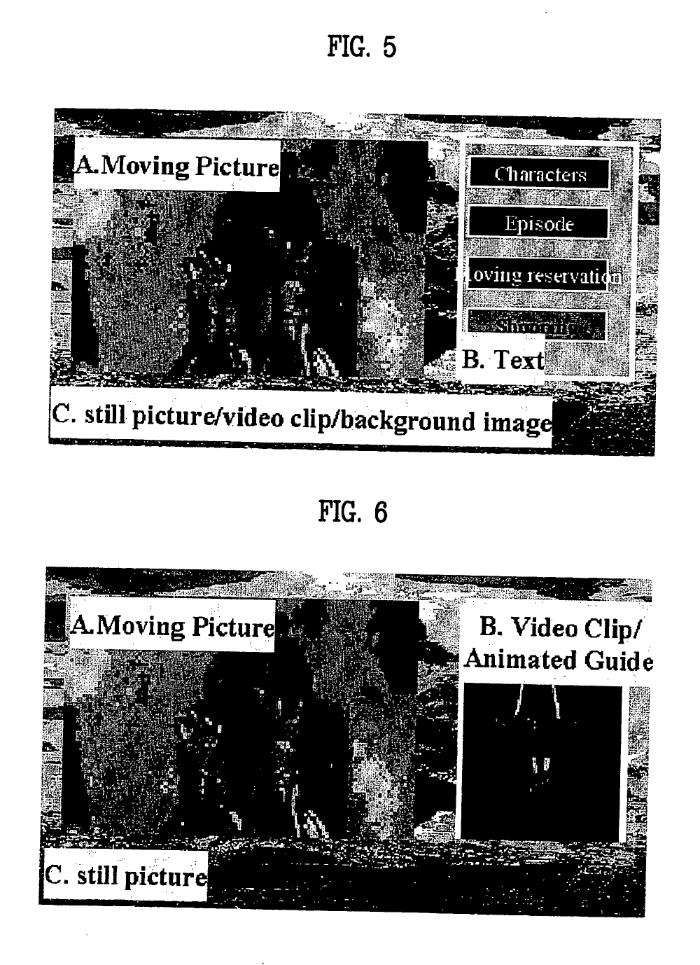

FIG. 5 is a pictorial diagram of an image of data broadcast according to one embodiment of the present invention. An area-A in FIG. 5 represents a moving picture image of a channel selected by a user and corresponds to an image decoded by the dual video decoder 230. An area-B in FIG. 5 displays associated information of a program and user-selecting information on a screen in the format of text and corresponds to an image processed via the OSD/graphic processing unit 240. And, an area-C in FIG. 5 indicates a background image area, is one of the video clip data, and corresponds to an image decoded via the dual video decoder 230. Moreover, the aforesaid intra frame still picture or video drip image is mainly used as the image configuring elements corresponding to the area-C.

In case of the animation OSD or the video clip data obtained via Internet or the like, a total valid video sequence should be previously stored within the memory range. In such a video source, I, P, and B picture structures exist. Hence, a reference frame previously decoded is needed to restore the video. Such a reference frame memory area is reserved until the corresponding video clip is displayed on a screen, and can be utilized for another use later.

FIG. 6 is a pictorial diagram of an image of data broadcast according to another embodiment of the present invention, in which animation OSD or other video clip is displayed via a sub-screen corresponding to an area-B. An area-A in FIG. 6 represents a moving picture image of a user-selecting channel and corresponds to an image decoded via the dual video decoder 230. An area-B represents an animation OSD image and corresponds to an image decoded via the dual video decoder 230. And, a background image of an area-C corresponds to an image processed by the OSD/graphic processing unit 240. If the area-C is transferred as an intra frame or video drip, one of B and C is used in software decoding of the host processor 210.

Thus, the video decoding apparatus according to the present invention can decode the MPEG intra frame still picture transferred via the data broadcasting performed as a sort of two-way TV service and the video drip image having a slightly varying effect via the consecutive video sequence as well as restores the moving picture of the main screen via the video decoder.

And, by decoding the animation OSD capable of implementing a motional OSD image with an additional low cost and/or the moving picture clip obtained via modem, cable, Internet, or the like, the video decoding apparatus according to the present invention maximally the available resources to support the efficient implementation of the TV receiver system.

As explained in the above description, the video decoding apparatus and method according to the present invention restores the video clip data such as the data broadcast intra frame still picture, video drip, and the like using the video decoder and then outputs the restored video clip data to the screen, thereby reducing the load and memory access of the host processor. Therefore, the present invention enhances the performance of the digital TV receiver.

And, the present invention decodes the animation OSD data via the video decoder to output to the screen, thereby implementing high quality OSD with an inexpensive cost.

Moreover, the present invention restores the video clip obtained via modem, Internet, mobile storage device, or the like using the video decoder and then outputs the restored video clip to the screen, thereby providing a viewer with supplementary convenience.

It will be apparent to those skilled in the art that various modifications and variations can be made in the present invention. Thus, it is intended that the present invention covers the modifications and variations of this invention provided they come within the scope of the appended claims and their equivalents.

1. An apparatus for decoding video, comprising:
a memory storing a compressed moving picture data of a specific channel transferred in a video packet format and a compressed video clip data transferred in a data packet format in designated areas, respectively;
a host processor controlling a memory range and location of the compressed video clip data;
a selection unit selecting to output one of the compressed moving picture data and the video clip data; and
a video decoder decoding the compressed data outputted from the selection unit by applying MPEG algorithm thereto under a control of the host processor.

2. The apparatus of claim 1, wherein the video clip data is a compressed encoded data having MPEG coding algorithm applied thereto.

3. The apparatus of claim 1, wherein the video clip data includes an MPEG intra frame still picture data or a video drip image data transferred in the data packet format via at least one of a modem, Internet, and a cable.

4. The apparatus of claim 1, wherein the video clip data includes an animation OSD data.

5. The apparatus of claim 1, wherein the host processor sets up a location and storage range of a memory in firstly decoding a first picture if the inputted video clip data is a consecutive video sequence.

6. The apparatus of claim 1, wherein if the inputted video clip data is a single still picture, the host processor sets up a location and storage range of a memory whenever the still picture is inputted.

7. The apparatus of claim 1, wherein if the data inputted to the video decoder is the video clip data, the host processor controls the video decoder to search a bit stream from a start address of a memory having the video clip data stored therein so that the video recorder starts to decode the bit stream by picture unit after a valid GOP has been found.

8. The apparatus of claim 1, wherein if the video decoder is a dual video decoder, the compressed moving picture data and the compressed video clip data are simultaneously received so that the received data are decoded to be outputted.

9. An apparatus for decoding video, comprising:
a memory storing compressed moving picture data of first and second channels transferred in a video packet format and a compressed video clip data transferred in a data packet format in designated areas, respectively;
a host processor controlling a memory range and location of the compressed video clip data;
a selection unit selectively outputting at least one of the compressed moving picture data of the first and second channels and the video clip data;
a dual video decoder simultaneously decoding the compressed moving picture data of the channels selected by a user via the selection unit and the video clip data by picture unit by applying MPEG algorithm thereto under a control of the host processor if the compressed moving picture data of the channels selected by the user via the selection unit and the video clip data are outputted; and
a video synthesizing unit blending to output a moving picture and a video clip image outputted from the dual video decoder according to a predefined blending ratio.

10. The apparatus of claim 9, wherein the host processor sets up a location and storage range of a memory in firstly decoding a first picture if the inputted video clip data is a consecutive video sequence.

11. The apparatus of claim 9, wherein if the inputted video clip data is a single still picture, the host processor sets up a location and storage range of a memory whenever the still picture is inputted.

12. The apparatus of claim 9, wherein if the data inputted to the video decoder is the video clip data, the host processor controls the dual video decoder to search a bit stream from a start address of a memory having the video clip data stored therein so that the dual video recorder starts to decode the bit stream by picture unit after a valid GOP has been found.

13. In a digital TV receiver including a memory storing a compressed moving picture data transferred in a video packet format and a compressed video clip data transferred in a data packet format in designated areas, respectively, a method of decoding video, comprising:
a step (a) of selecting to output one of the compressed moving picture data and the video clip data from the memory;
a step (b) of if the video clip data is selected and outputted in the step (a), deciding whether the video clip data is a valid MPEG data; and
a step (c) of if the video clip data is decided as the valid MPEG data in the step (b), performing video decoding on the valid video clip data within a range of the memory by MPEG decoding algorithm.

14. The method of claim 13, wherein in the step (b), if a valid GOP is detected by searching a bit stream in turn from a start location of the memory having the video clip data stored therein, it is decided as the valid MPEG data.

15. The method of claim 14, wherein in the step (c), decoding is performed on a bit stream after the valid GOP is found in searching the bit stream from a start address of the memory having the video clip data stored therein.

16. The method of claim 13, wherein the video clip data includes an MPEG intra frame still picture data or a video drip image data transferred in the data packet format via at least one of a modem, Internet, and a cable.

17. The method of claim 13, wherein the video clip data includes an animation OSD data.

18. In a digital TV receiver including a memory storing compressed moving picture data of first and second channels transferred in a video packet format and a compressed video clip data transferred in a data packet format in designated areas, respectively, a method of decoding video, comprising:
a step (a) of selecting to output at least one of the compressed moving picture data and the compressed video clip data from the memory;
a step (b) of if the compressed moving picture data of one of the first and second channels and the video clip data are selected and outputted, simultaneously decoding to output the compressed moving picture data and the video clip data; and
a step (c) of blending to display a moving picture and a video clip image outputted in the step (b) according to a predefined blending ratio.

19. The method of claim 18, wherein in the step (b), video decoding is carried out on the video clip data valid within a range of the memory by picture unit.

20. The method of claim 18, wherein in the step (b), video decoding is performed on a bit stream after the valid GOP is found in searching the bit stream from a start address of the memory having the video clip data stored therein.
